(19) United States
(12) Patent Application Publication
(10) Pub. No.: US 2026/0348895 A1
(43) Pub. Date: Nov. 5, 2026

(54) Method for Testing a Pressure Vessel, and Test Arrangement for a Pressure Vessel

(71) Applicant: BAYERISCHE MOTOREN WERKE AKTIENGESELLSCHAFT, Muenchen (DE)

(72) Inventor: Klaus SZOUCSEK, Zirndorf (DE)

(21) Appl. No.: 19/109,603

(22) PCT Filed: Aug. 18, 2023
(86) PCT No.: PCT/EP2023/072790

§ 371 Date: Mar. 7, 2025

(30) Foreign Application Priority Data
Sep. 9, 2022 (DE) 10 2022 123 002.3

(51) Int. Cl. G01N 27/04; G01N 27/06

(52) U.S. Cl. CPC G01N 27/041; G01N 27/06

(57) ABSTRACT

A method for testing a pressure vessel includes: placing at least one electrode in a medium storage space of a pressure vessel, the pressure vessel comprising a metallic hollow body, and an inner wall of the metallic hollow body being coated with an insulating material in order to insulate the medium storage space from the metallic hollow body; filling the medium storage space with a test liquid in order to generate a test pressure in the medium storage space; measuring a current and/or resistance between the at least one electrode and the metallic hollow body while the test pressure is generated in the medium storage space; and determining an insulation property of the insulating material based on a result of the current and/or resistance measurement.

### BACKGROUND AND SUMMARY

The present disclosure relates to a method for testing a pressure vessel and to a test arrangement for a pressure vessel. The present disclosure relates in particular to testing of a permeation barrier, for example a polymeric coating, of a steel tank during a pressure test.

For historical reasons, a considerable number of motor vehicles are currently still powered by an internal combustion engine. Since fossil fuels are limited in their availability and since the exhaust emissions from such internal combustion engines cause environmental pollution, the trend is toward alternative propulsion technologies, in particular the electric drive. Electric vehicles can be provided, for example, with lithium batteries or fuel cells that serve as energy sources for the electric drive.

Fuel cells convert the chemical energy of hydrogen into electricity, forming only water vapor without any nitrogen oxides or CO₂. Fuel cells are therefore generally environmentally friendly. One challenge with fuel cell-powered vehicles is storing the hydrogen in the vehicle. Hydrogen tanks that are subject to high safety requirements are used for this purpose, since the hydrogen tanks are often filled at up to 875 bar. Moreover, hydrogen is a corrosive medium, which means that only a few steels are suitable for the production of hydrogen tanks.

Hydrogen tanks are typically made of carbon fiber-reinforced polymer (CFRP). CFRP is a robust material and is not rendered brittle by hydrogen. However, the production of hydrogen tanks made of CFRP is complex and costly, and so the production costs for such hydrogen tanks are high.

JP 2009-133767 A relates to a tank for supplying a medical fluid. The tank comprises a tank body, the inside of which is lined with a corrosion-resistant material. In one example, a resistance measuring device is connected to an outside of the tank body and to an electrode of a leakage inspection device in order to determine a condition of an insulation layer.

JP 2000-081362 A relates to a leakage detection device for a fluid tank. An internal electrode is arranged in a fluid of the fluid tank, and the surface of the inner wall of said fluid tank is covered by a lining layer.

It is an object of the present disclosure to specify a method for testing a pressure vessel and a test arrangement for a pressure vessel that allow efficient quality testing of a pressure vessel. In particular, it is an object of the present disclosure to allow rapid and reliable testing of an insulation coating of a steel tank.

This object may be achieved by the subject matter of the independent claims. Advantageous configurations are specified in the dependent claims.

According to an independent aspect of the present disclosure, a method for testing a pressure vessel, in particular a steel tank, is specified. The method comprises arranging at least one electrode in a medium storage space of the pressure vessel, the pressure vessel comprising a metallic hollow body and an inner wall of the metallic hollow body being coated with an insulation material in order to insulate the medium storage space from the metallic hollow body; filling the medium storage space with a test fluid in order to generate in the medium storage space a test pressure for a pressure test; carrying out, for a coating quality test, a current and/or resistance measurement between the at least one electrode and the metallic hollow body while the test pressure is applied to the medium storage space; and determining an insulation property of the insulation material on the basis of a result from the current and/or resistance measurement.

According to the disclosure, both a pressure test and a coating quality test are carried out in a single process step. For this purpose, the medium storage space of the pressure vessel is filled with a test fluid in order to generate a test pressure for the pressure test. Moreover, an electrode is arranged in the medium storage space and thus surrounded by the test fluid. Coating quality is tested by measuring a current flow between the electrode and the metallic hollow body, or a corresponding resistance. In particular, current is conducted by the test fluid, meaning that a current flows between the electrode and the metallic hollow body in the case of a defective coating. By contrast, in the case of a flawless coating, there is essentially no flow of current. The current and/or resistance measurement therefore makes it possible to infer the quality of the coating. The result achieved is efficient quality testing of the pressure vessel.

For the current and/or resistance measurement, a defined voltage is applied to the at least one electrode and the metallic hollow body, such that the current flow between the at least one electrode and the metallic hollow body, or a corresponding resistance, can be measured. For example, current can be measured with an amperemeter, and resistance can be measured with an ohmmeter.

Preferably, the test pressure is 1000 bar or higher. For example, the test pressure may be 1050 bar or higher.

Preferably, the test fluid is water. However, the present disclosure is not restricted to this and the test fluid may be any other electrically conductive fluid that allows the current and/or resistance measurement.

Preferably, the determining of the insulation property of the insulation material on the basis of a result from the current and/or resistance measurement comprises comparing a current flow between the at least one electrode and the metallic hollow body, or a corresponding resistance value, with a threshold.

In some embodiments, it may be determined that the pressure vessel is an in-spec part if the current flow is (equal to or) less than the threshold and that the pressure vessel is an out-of-spec part if the current flow is (equal to or) greater than the threshold. Similarly, it may be determined that the pressure vessel is an in-spec part if the resistance value is (equal to or) greater than the threshold and that the pressure vessel is an out-of-spec part if the resistance value is (equal to or) less than the threshold. In particular, the current flow, or the corresponding resistance value, may indicate a presence of defects in the insulation material. The defects may be holes which expose the metallic hollow body to the medium storage space and thus allow current flow.

“In-spec part” generally refers to components which meet specific quality requirements. Accordingly, components which fail to meet the quality requirements can be referred to as “out-of-spec parts”.

The threshold may be ascertained by way of suitable tests. For example, the threshold may be defined on the basis of quality criteria, which may be legally regulated, for distinguishing between an in-spec part and an out-of-spec part. In some embodiments, holes may be introduced specifically into a coating of a pressure vessel, so that the current flow, or corresponding resistance value, at which the presence of holes can be inferred can be ascertained. Said current flow, or the corresponding resistance value, may then be used, for example, to define the above-explained threshold for distinguishing between an in-spec part and an out-of-spec part.

Preferably, the at least one electrode comprises a first electrode and a second electrode.

Preferably, the method further comprises carrying out a first current and/or resistance measurement between the first electrode and the metallic hollow body and a second current and/or resistance measurement between the second electrode and the metallic hollow body; and determining the insulation property of the insulation material on the basis of a result from the first current and/or resistance measurement and a result from the second current and/or resistance measurement. This makes it possible to create redundancy to improve reliability in the test result for the pressure vessel.

Additionally or alternatively, the method may further comprise carrying out a current and/or resistance measurement between the first electrode and the second electrode and determining a condition of the test fluid on the basis of a result from the current and/or resistance measurement between the first electrode and the second electrode. This makes it possible for an additional function, namely quality testing of the test fluid, to be provided by the method according to the disclosure without any change in hardware. For example, a conductivity of the test fluid may rise with increasing age because of contaminants, and this can be detected by the current and/or resistance measurement.

The method according to the disclosure in some embodiments may be executed at least semi-automatically, and preferably fully automatically, by means of suitable software.

Accordingly, according to a further independent aspect of the present disclosure, a software (SW) program is specified. The SW program may be configured to be executed on one or more processors and to thereby execute the method for testing a pressure vessel that is described in this document.

According to a further independent aspect of the present disclosure, a storage medium is specified. The storage medium may comprise a SW program configured to be executed on one or more processors and to thereby execute the method for testing a pressure vessel that is described in this document.

According to a further independent aspect of the present disclosure, software containing program code is specified. The software is configured to carry out the method for testing a pressure vessel when the software is running on one or more software-controlled devices.

According to a further independent aspect of the present disclosure, a system for testing a pressure vessel is specified. The system comprises one or more processors; and contains at least one memory which is connected to the one or more processors and instructions which can be executed by the one or more processors in order to execute the method for testing a pressure vessel that is described in this document.

A processor or a processor module is a programmable execution unit, i.e., a machine or an electronic circuit, which controls other elements according to transferred commands and, in doing so, drives an algorithm (process).

Preferably, the pressure vessel is configured for use or installation in vehicles. The term “vehicle” includes automobiles, trucks, buses, recreational vehicles, motorcycles, etc., which serve for transporting passengers, goods, etc. In particular, the term includes motor vehicles for passenger transport.

Preferably, the metallic hollow body comprises steel. The steel may be a high-strength steel, which may have, for example, a tensile strength of 500 MPa or higher, 1000 MPa or higher, or 2000 MPa or higher. In some embodiments, the steel may be 300M steel or V132 steel.

The coating of the inner wall of the metallic hollow body with the insulation material protects the metallic material from corrosion by the stored medium, thus allowing even the use of metallic pressure vessels for storage of corrosive media. This can reduce costs for the storage of corrosive media, since metallic pressure vessels are more cost-effective to produce than, for example, CFRP tanks. Moreover, metal is easier to recycle than, for example, CFRP. Furthermore, at the same resistance to pressure, the metallic pressure vessel can have a thinner wall compared to, for example, a CFRP tank, and so, at the same size, the pressure vessel can be filled with more medium and hold a larger reserve of medium.

Preferably, the pressure vessel is configured for the storage of a gaseous and/or liquid medium. In other words, the medium stored in the pressure vessel may be a gas and/or a liquid. In some embodiments, the medium stored in the pressure vessel may be solely a gas or solely a liquid. In other embodiments, the medium stored in the pressure vessel may comprise a gaseous fraction and a liquid fraction. For example, a gaseous medium may also be present above the liquid.

Preferably, the pressure vessel is a hydrogen tank. The coating of the inner wall of the metallic hollow body with the insulation material protects the metallic material from corrosion by the hydrogen, thus allowing, for example, the use of steel tanks for storing hydrogen. This can reduce costs for hydrogen storage, for example in vehicles, especially since steel tanks are more cost-effective to produce than, for example, CFRP tanks. Furthermore, at the same resistance to pressure, the pressure vessel according to the disclosure can have a thinner wall compared to, for example, a CFRP tank, and so, at the same installation space in a vehicle, more hydrogen can be stored, which can increase the range of the vehicle.

Preferably, the insulation material forms a permeation barrier. The term “permeation” generally refers to the process in which a substance or permeate penetrates or migrates through a solid body. Accordingly, the insulation material prevents the medium in the medium storage space from reaching and corroding the metallic hollow body. The insulation material may be selected according to the medium for which the pressure vessel is intended. If the medium stored in the pressure vessel comprises a gaseous fraction and a liquid fraction, the insulation material may form a permeation barrier for the two physical states of the medium.

In some embodiments, the insulation material may form a hydrogen permeation barrier.

Preferably, the insulation material comprises a polymer. The insulation material may be suitably selected to prevent permeation by the medium to be stored in the pressure vessel.

Preferably, the insulation material is selected from the group comprising or consisting of ethylene vinyl alcohol (EVOH), epoxide, silicon dioxide, polytetrafluoroethylene (PTFE), Teflon, liquid crystal polymers (LCP) and combinations thereof.

Preferably, the inner wall of the metallic hollow body is coated with a monolayer of the insulation material. However, the present disclosure is not limited to this and the insulation material may comprise multiple layers, for example multiple layers of different materials.

Preferably, a layer thickness of the insulation material on the inner wall of the metallic hollow body is in the range between 10 μm and 500 μm, in particular between 50 μm and 200 μm.

According to a further independent aspect of the present disclosure, a test arrangement for a pressure vessel is specified.

The test arrangement may be configured to implement the aspects of the method for testing a pressure vessel that is described in this document.

The test arrangement comprises at least one electrode arrangeable in a medium storage space of the pressure vessel, the pressure vessel comprising a metallic hollow body and an inner wall of the metallic hollow body being coated with an insulation material in order to insulate the medium storage space from the metallic hollow body; a pressure generation device configured to introduce a test fluid into the medium storage space and to generate in the medium storage space a test pressure for a pressure test; and a current and/or resistance measurement device connectable to the at least one electrode and the metallic hollow body in order to carry out a current and/or resistance measurement between the at least one electrode and the metallic hollow body for determination of an insulation property of the insulation material in a coating quality test.

Preferably, the at least one electrode comprises a first electrode and a second electrode. Optionally, one or more further electrodes may be provided.

Preferably, the current and/or resistance measurement device is configured to carry out a first current and/or resistance measurement between the first electrode and the metallic hollow body and a second current and/or resistance measurement between the second electrode and the metallic hollow body. This makes it possible to create redundancy to improve reliability in the test result for the pressure vessel.

Additionally or alternatively, the current and/or resistance measurement device may be configured to carry out a current and/or resistance measurement between the first electrode and the second electrode in order to determine a condition of the test fluid. For example, a conductivity of the test fluid may rise with increasing age because of contaminants, and this can be detected by the measurement of the current flow or resistance between the first electrode and the second electrode, both of which are surrounded by or dipped into the test fluid.

Preferably, the test arrangement further comprises at least one adapter configured to be connected to at least one inlet opening and/or outlet opening of the medium storage space. For example, the at least one adapter may be at least partly inserted into the inlet opening and/or outlet opening of the medium storage space. The at least one adapter is typically connectable to the inlet opening and/or outlet opening substantially water-tightly. This makes it possible to prevent test fluid from leaking out of the at least one inlet opening and/or outlet opening.

Preferably, the at least one adapter is made of a polymer, ceramic or polymer-coated metal. The at least one adapter may electrically insulate the at least one electrode from the metallic hollow body, thus allowing reliable current and/or resistance measurement between the at least one electrode and the metallic hollow body.

Preferably, the at least one adapter is configured to introduce the test fluid into the medium storage space and/or to discharge it from the medium storage space.

In some embodiments, the at least one adapter may comprise a first adapter connectable to an inlet opening of the medium storage space. For example, the first adapter may be connected to the pressure generation device via a test fluid supply line in order to introduce the test fluid provided by the pressure generation device into the medium storage space.

Additionally or alternatively, the at least one adapter may comprise a second adapter connectable to an outlet opening of the medium storage space. For example, the second adapter may be connected to a test fluid discharge line, such that the test fluid can be discharged from the medium storage space once the test procedure has ended.

The inlet opening of the medium storage space is, in this case, an opening through which the test fluid is introduced into the medium storage space. The outlet opening of the medium storage space may be an opening through which the test fluid is discharged from the medium storage space.

Preferably, the inlet opening and the outlet opening are arranged on opposite ends or sides of the medium storage space.

In other embodiments, a single opening may serve as inlet opening and outlet opening.

Preferably, the at least one electrode extends through the at least one adapter. This means that the at least one electrode protrudes into the medium storage space when the adapter is connected to the inlet opening and/or outlet opening, such that the at least one electrode is surrounded by or dipped into the test fluid during the test procedure.

Preferably, the at least one electrode is rod-shaped.

### BRIEF DESCRIPTION OF THE DRAWINGS

Exemplary embodiments of the disclosure are illustrated in the figures and will be described in greater detail below. In the figures:

FIG. 1 shows a flow chart of a method for testing a pressure vessel according to embodiments of the present disclosure,

FIG. 2 shows schematically a test arrangement and a pressure vessel according to embodiments of the present disclosure, and

FIG. 3 shows schematically a test arrangement and a pressure vessel according to further embodiments of the present disclosure.

### DETAILED DESCRIPTION OF THE DRAWINGS

Unless otherwise noted, the same reference signs will be used below for identical and identically acting elements.

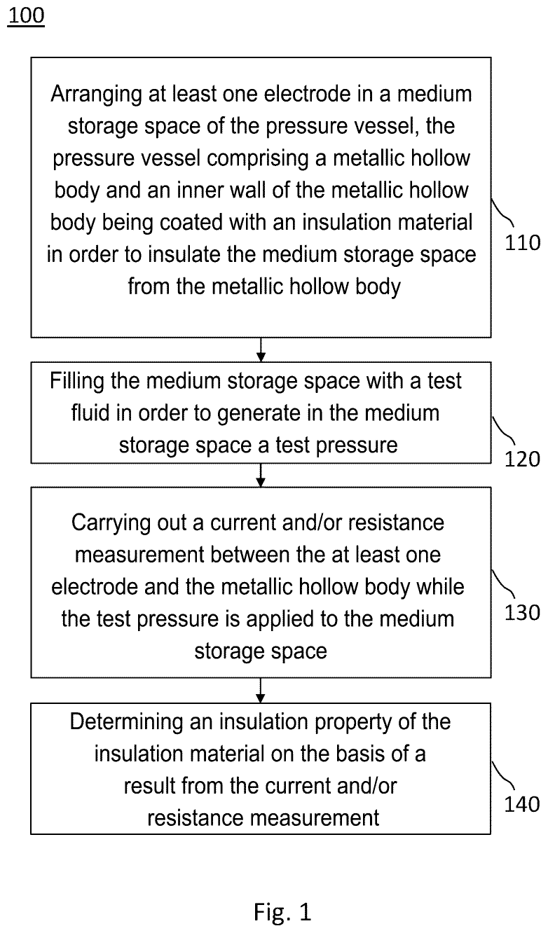

FIG. 1 shows schematically a flow chart of a method 100 for testing a pressure vessel according to embodiments of the present disclosure.

The method 100 comprises, in block 110, arranging at least one electrode in a medium storage space of the pressure vessel, the pressure vessel comprising a metallic hollow body and an inner wall of the metallic hollow body being coated with an insulation material in order to insulate the medium storage space from the metallic hollow body; in block 120, filling the medium storage space with a test fluid in order to generate in the medium storage space a test pressure; in block 130, carrying out a current and/or resistance measurement between the at least one electrode and the metallic hollow body while the test pressure is applied to the medium storage space; and in block 140, determining an insulation property of the insulation material on the basis of a result from the current and/or resistance measurement.

The method 100 combines a hydraulic pressure test and ascertainment of coating quality in a single step. In the case of a hydraulic pressure test, the pressure vessel may be filled with a test fluid, for example water, ensuring that air is no longer present in the pressure vessel. Thereafter, the water may be compressed to approx. 150% NWP (e.g., 1.5×700 bar=1050 bar) and the pressure held for a certain length of time.

During this holding phase, the coating quality is measured at the same time by applying a voltage across an electrode present in the test fluid and the metallic hollow body. In the case of a good coating without any defects, there is no flow (or scarcely any flow) of current. In the case of the presence of a defect, the test fluid is in contact with the metallic hollow body and thus forms a conductive connection between the electrode and the vessel wall, such that a relatively large electric current flows. Control samples allow a threshold for the electric current flow or the corresponding electrical resistance to be defined, such that an in-spec part can be distinguished from an out-of-spec part.

Following the holding phase, the test pressure may be reduced, the test fluid removed from the vessel, and a drying procedure carried out. Thereafter, the pressure vessel is finished or it passes to a next process step of an end-of-line test.

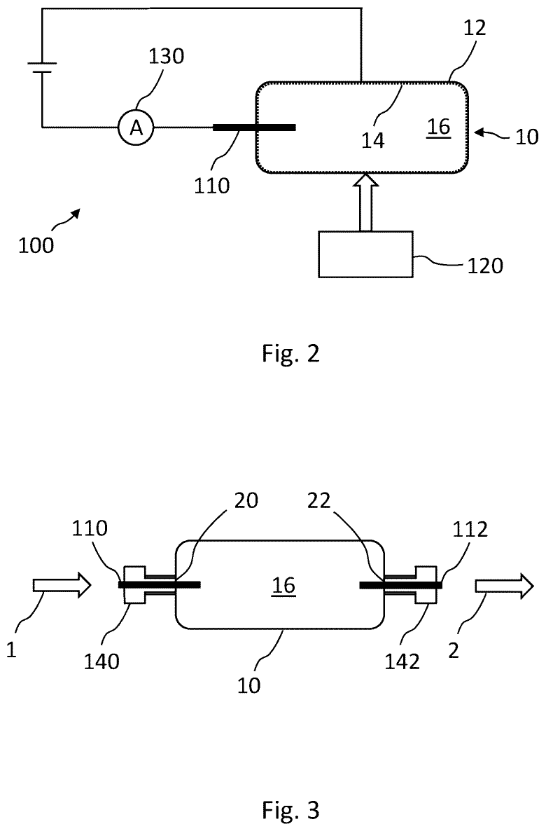

FIG. 2 shows schematically a test arrangement 100 and a pressure vessel 10 according to embodiments of the present disclosure.

The test arrangement 100 comprises at least one electrode 110 arranged in a medium storage space 16 of the pressure vessel 10, the pressure vessel 10 comprising a metallic hollow body 12 and an inner wall of the metallic hollow body 12 being coated with an insulation material 14 in order to insulate the medium storage space 16 from the metallic hollow body 12; a pressure generation device 120 configured to introduce a test fluid into the medium storage space 16 and to generate in the medium storage space 16 a test pressure; and a current and/or resistance measurement device 130 connected to the at least one electrode 110 and the metallic hollow body 12 in order to carry out a current and/or resistance measurement between the at least one electrode 110 and the metallic hollow body 12 for determination of an insulation property of the insulation material 14.

For the current and/or resistance measurement, a defined voltage is applied to the at least one electrode 110 and the metallic hollow body 12, such that the current flow between the at least one electrode 110 and the metallic hollow body 12, or a corresponding resistance, can be measured. For example, current can be measured with an amperemeter, and resistance can be measured with an ohmmeter. In the example of FIG. 2, an amperemeter is shown.

A quality of the coating or the insulation material 14 may be determined by comparing the current flow between the at least one electrode 110 and the metallic hollow body 12, or a corresponding resistance value, with a threshold. If, for example, holes are present in the coating, the current flow between the at least one electrode 110 and the metallic hollow body 12 is increased, or the resistance between the at least one electrode 110 and the metallic hollow body 12 is reduced.

If the current flow is above its threshold or if the resistance is below its threshold, the pressure vessel 10 may be designated as an out-of-spec part and, for example, sorted out. If, by contrast, the current flow is below its threshold or the resistance is above its threshold, the pressure vessel 10 may be designated as an in-spec part.

The test arrangement 100 may be calibrated by way of suitable tests. For example, holes may be introduced specifically into a coating of a pressure vessel, so that the current flow, or corresponding resistance value, at which the presence of holes in the coating can be inferred can be ascertained. The current flow, or the corresponding resistance value, may then be used, for example, to define the threshold for distinguishing between an in-spec part and an out-of-spec part.

The metallic hollow body 12 in some embodiments may comprise or consist of steel. The steel may be a high-strength steel, which may have, for example, a tensile strength of 500 MPa or higher, 1000 MPa or higher, or 2000 MPa or higher. The steel may be, for example, 300M steel or V132 steel.

In some embodiments, the pressure vessel 10 may be a hydrogen tank, for example for use in fuel cell-powered vehicles. The coating of the inner wall of the metallic hollow body 12 with the insulation material 14 protects the metallic material from corrosion by the hydrogen, thus allowing, for example, the use of steel tanks for storing hydrogen. This can reduce costs for hydrogen storage in vehicles, especially since steel tanks are more cost-effective to produce than, for example, CFRP tanks. Furthermore, at the same resistance to pressure, the pressure vessel according to the disclosure can have a thinner wall compared to, for example, a CFRP tank, and so, at the same installation space in a vehicle, more hydrogen can be stored, which can increase the range of the vehicle.

The insulation material 14 typically forms a permeation barrier, for example a hydrogen permeation barrier. In some embodiments, the insulation material may be selected from the group comprising or consisting of ethylene vinyl alcohol (EVOH), epoxide, silicon dioxide, polytetrafluoroethylene (PTFE), Teflon, liquid crystal polymers (LCP) and combinations thereof.

A layer thickness of the insulation material 14 on the inner wall of the metallic hollow body 12 may be in the range between 10 μm and 500 μm, in particular between 50 μm and 200 μm.

FIG. 3 shows schematically a test arrangement and a pressure vessel 10 according to further embodiments of the present disclosure. The test arrangement of FIG. 3 is similar to the test arrangement of FIG. 2, and in respect of an explanation of identical or similar aspects, reference is made to FIG. 2 and the associated description.

The test arrangement comprises a first electrode 110 and a second electrode 112. Optionally, one or more further electrodes may be provided. The first electrode 110 and the second electrode 112 are typically both rod-shaped.

The test arrangement further comprises a first adapter 140 which is connected to, in particular inserted into, an inlet opening 20 of the medium storage space 16. For example, the first adapter 140 may be connected to the pressure generation device via a test fluid supply line (not shown) and introduce the test fluid provided by the pressure generation device into the medium storage space (shown by arrow 1).

Moreover, the test arrangement comprises a second adapter 142 which is connected to, in particular inserted into, an outlet opening 22 of the medium storage space 16. For example, the second adapter 142 may be connected to a test fluid discharge line (not shown), such that the test fluid can be discharged from the medium storage space 16 (shown by arrow 2) once the test procedure has ended.

The inlet opening 20 and the outlet opening 22 may be arranged on opposite ends or sides of the medium storage space 16.

The first electrode 110 may extend through the first adapter 140. This means that the first electrode 110 protrudes into the medium storage space 16 when the first adapter 140 is inserted into the inlet opening 20, such that the first electrode 110 is surrounded by or dipped into the test fluid during the test procedure. The first adapter 140 may electrically insulate the first electrode 110 from the metallic hollow body 12, thus allowing reliable current and/or resistance measurement between the first electrode 110 and the metallic hollow body 12.

The second electrode 112 may extend through the second adapter 142. This means that the second electrode 112 protrudes into the medium storage space 16 when the second adapter 142 is inserted into the outlet opening 22, such that the second electrode 112 is surrounded by or dipped into the test fluid during the test procedure. The second adapter 142 may electrically insulate the second electrode 112 from the metallic hollow body 12, thus allowing reliable current and/or resistance measurement between the second electrode 112 and the metallic hollow body 12.

The current and/or resistance measurement device of the test arrangement may be configured to carry out a first current and/or resistance measurement between the first electrode 110 and the metallic hollow body 12 and a second current and/or resistance measurement between the second electrode 112 and the metallic hollow body 12. This makes it possible to create redundancy to improve reliability in the coating test.

Additionally or alternatively, the current and/or resistance measurement device may be configured to carry out a current and/or resistance measurement between the first electrode 110 and the second electrode 120 in order to determine a condition of the test fluid. For example, a conductivity of the test fluid may rise with increasing age because of contaminants, and this can be detected by the measurement of the current flow or resistance between the first electrode 110 and the second electrode 112, both of which are surrounded by or dipped into the test fluid.

According to the disclosure, both a pressure test and a coating quality test may be carried out in a single process step. For this purpose, the medium storage space of the pressure vessel is filled with a test fluid in order to generate a test pressure for the pressure test. Moreover, an electrode is arranged in the medium storage space and thus surrounded by the test fluid. Coating quality is tested by measuring a current flow between the electrode and the metallic hollow body, or a corresponding resistance. In particular, current is conducted by the test fluid, meaning that a current flows between the electrode and the metallic hollow body in the case of a defective coating. By contrast, in the case of a flawless coating, there is essentially no flow of current. The current and/or resistance measurement therefore makes it possible to infer the quality of the coating. The result achieved is efficient quality testing of the pressure vessel.

Although the invention has been illustrated and elucidated in detail by way of preferred exemplary embodiments, the invention is not limited by the examples disclosed, and other variations may be derived therefrom by a person skilled in the art without departing from the scope of protection of the invention. It is therefore clear that there is a large number of possible variations. It is likewise clear that embodiments mentioned by way of example are in reality only examples that are not to be construed in any way as limiting, for instance, the scope of protection, the possible applications or the configuration of the invention. Rather, the description above and the description of the figures will enable a person skilled in the art to implement the illustrative embodiments specifically; said person, with knowledge of the disclosed inventive concept, will be able to make a variety of modifications, for example with respect to the function or arrangement of individual elements mentioned in an illustrative embodiment, without departing from the scope of protection defined by the claims and legal equivalents thereof, such as further elucidations in the description.

1-10. (canceled)

11. A method for testing a pressure vessel, the method comprising:
arranging at least one electrode in a medium storage space of a pressure vessel, the pressure vessel comprising a metallic hollow body and an inner wall of the metallic hollow body being coated with an insulation material in order to insulate the medium storage space from the metallic hollow body;
filling the medium storage space with a test fluid, whereby a test pressure for a pressure test is generated in the medium storage space;
carrying out, for a coating quality test, a current and/or resistance measurement between the at least one electrode and the metallic hollow body while the test pressure is generated in the medium storage space; and
determining an insulation property of the insulation material on the basis of a result from the current and/or resistance measurement.

12. The method according to claim 11, wherein
the test pressure is at least 1000 bar, and/or
the test fluid comprises water.

13. The method according to claim 11, wherein the determining of the insulation property of the insulation material on the basis of a result from the current and/or resistance measurement comprises:
comparing a current flow between the at least one electrode and the metallic hollow body with a threshold, and determining that the pressure vessel is an in-spec part if the current flow is less than the threshold and that the pressure vessel is an out-of-spec part if the current flow is greater than the threshold; and/or
comparing a resistance value between the at least one electrode and the metallic hollow body with a threshold, and determining that the pressure vessel is an in-spec part if the resistance value is greater than the threshold and that the pressure vessel is an out-of-spec part if the resistance value is less than the threshold.

14. The method according to claim 13, wherein the current flow greater than the threshold, or the resistance value less than the threshold, indicates a presence of defects in the insulation material, the defects being holes which expose the metallic hollow body to the medium storage space.

15. The method according to claim 11, wherein the at least one electrode comprises a first electrode and a second electrode, and wherein the method further comprises:
carrying out a first current and/or resistance measurement between the first electrode and the metallic hollow body and a second current and/or resistance measurement between the second electrode and the metallic hollow body; and
determining the insulation property of the insulation material on the basis of a result from the first current and/or resistance measurement and a result from the second current and/or resistance measurement.

16. The method according to claim 11, wherein the at least one electrode comprises a first electrode and a second electrode, and wherein the method further comprises:
carrying out a current and/or resistance measurement between the first electrode and the second electrode; and
determining a condition of the test fluid on the basis of a result from the current and/or resistance measurement between the first electrode and the second electrode.

17. The method according to claim 11, wherein
the metallic hollow body comprises steel, and/or
the pressure vessel is configured for the storage of a gaseous and/or liquid medium.

18. The method according to claim 11, wherein the pressure vessel is a hydrogen tank, and/or
the insulation material forms a hydrogen permeation barrier.

19. The method according to claim 11, wherein
the insulation material is a polymer, and/or
the insulation material is selected from the group consisting of ethylene vinyl alcohol, epoxide, silicon dioxide, polytetrafluoroethylene, Teflon, liquid crystal polymers, and combinations thereof.

20. The method according to claim 11, wherein
the inner wall of the metallic hollow body is coated with a monolayer of the insulation material, and/or
a layer thickness of the insulation material on the inner wall of the metallic hollow body is in the range between 10 μm and 500 μm.

21. The method according to claim 20, wherein the layer thickness is in the range between 50 μm and 200 μm.

22. A test arrangement for a pressure vessel, the test arrangement comprising:
at least one electrode arrangeable in a medium storage space of a pressure vessel, the pressure vessel comprising a metallic hollow body and an inner wall of the metallic hollow body being coated with an insulation material in order to insulate the medium storage space from the metallic hollow body;
a pressure generation device configured to introduce a test fluid into the medium storage space and to generate in the medium storage space a test pressure for a pressure test; and
a current and/or resistance measurement device connectable to the at least one electrode and the metallic hollow body in order to carry out a current and/or resistance measurement between the at least one electrode and the metallic hollow body for determination of an insulation property of the insulation material in a coating quality test.

23. The test arrangement according to claim 22, wherein the at least one electrode comprises a first electrode and a second electrode, and wherein the current and/or resistance measurement device is configured to:
carry out a first current and/or resistance measurement between the first electrode and the metallic hollow body and a second current and/or resistance measurement between the second electrode and the metallic hollow body; and/or
carry out a current and/or resistance measurement between the first electrode and the second electrode in order to determine a condition of the test fluid.

24. The test arrangement according to claim 22, further comprising at least one adapter configured to be connected to at least one inlet opening and/or outlet opening of the medium storage space, the at least one electrode extending through the at least one adapter, the at least one adapter being configured to electrically insulate the at least one electrode from the metallic hollow body.

25. The test arrangement according to claim 24, wherein the at least one adapter is configured to introduce the test fluid into the medium storage space and/or to discharge it from the medium storage space.
